(19) United States
(12) Patent Application Publication
(10) Pub. No.: US 2025/0148082 A1
(43) Pub. Date: May 8, 2025

(54) INFORMATION PROCESSING DEVICE AND METHOD FOR CONTROLLING INFORMATION PROCESSING DEVICE

(71) Applicant: Panasonic Automotive Systems Co., Ltd., Kanagawa (JP)

(72) Inventors: Nobutaka KAWAGUCHI, Osaka (JP); Kaoru YOKOTA, Hyogo (JP); Yuishi TORISAKI, Osaka (JP); Takumaru NAGAI, Osaka (JP)

(73) Assignee: Panasonic Automotive Systems Co., Ltd., Kanagawa (JP)

(21) Appl. No.: 19/017,057

(22) Filed: Jan. 10, 2025

Related U.S. Application Data
(63) Continuation of application No. PCT/JP2023/026176, filed on Jul. 18, 2023.

(30) Foreign Application Priority Data
Sep. 27, 2022 (JP) 2022-153318

(51) Int. Cl. G06F 21/56; G06F 21/53

(52) U.S. Cl. CPC G06F 21/566; G06F 21/53; G06F 2221/034

(57) ABSTRACT

An information processing device includes: a plurality of HIDS; a plurality of individual monitors each of which monitors an associated one of the plurality of HIDS; an integrated monitor that monitors each of the plurality of individual monitors; and a root monitor that monitors the integrated monitor. When the integrated monitor is compromised, the root monitor changes a monitoring target thereof from the integrated monitor to any of the plurality of individual monitors based on total monitoring information. When the integrated monitor is compromised, each of the plurality of individual monitors adds, to a monitoring target thereof, another individual monitor than the individual monitor based on the total monitoring information.

### CROSS REFERENCE TO RELATED APPLICATIONS

This is a continuation application of PCT International Application No. PCT/JP2023/026176 filed on Jul. 18, 2023, designating the United States of America, which is based on and claims priority of Japanese Patent Application No. 2022-153318 filed on Sep. 27, 2022.

### FIELD

The present disclosure relates to an information processing device and a method for controlling an information processing device.

### BACKGROUND

As security measures for firmware, not only integrity verification (secure boot) at the time of firmware startup but also constant integrity (runtime integrity (RI)) verification, i.e. integrity verification repeatedly performed after firmware startup, is desired.

An information processing device used in conventional security measures includes a monitor that operates in a non-secure region and a log collector that operates in a secure region (see, for example, Patent Literature (PTL) 1). The monitor monitors the presence or absence of an anomaly in the information processing device. The monitor then generates a monitoring log that indicates the monitoring result, and stores the generated monitoring log in a first memory. The log collector collects the monitoring log stored in the first memory, and stores the collected monitoring log in a second memory. The monitoring log stored in the second memory is transmitted to a security operation center (SOC).

### CITATION LIST

### Patent Literature

PTL 1: Japanese Unexamined Patent Application Publication No. 2020-129238

### SUMMARY

However, the foregoing conventional information processing device can be improved upon.

In view of this, the present disclosure provides an information processing device and a method for controlling an information processing device capable of improving upon the above related art.

An information processing device according to an aspect of the present disclosure is an information processing device including: a plurality of anomaly detectors each of which detects an anomaly in the information processing device; a plurality of first monitors each of which monitors an associated one of the plurality of anomaly detectors; a second monitor that monitors each of the plurality of first monitors; and a third monitor that monitors the second monitor, the third monitor being implemented in an execution environment that is more secure than an execution environment in which each of the plurality of anomaly detectors, the plurality of first monitors, and the second monitor is implemented, wherein when the second monitor is compromised, the third monitor changes a monitoring target thereof from the second monitor to any of the plurality of first monitors based on monitoring information that indicates information about the plurality of first monitors, and when the second monitor is compromised, each of the plurality of first monitors adds, to a monitoring target thereof, another first monitor than the first monitor based on the monitoring information.

Note that these general or specific aspects may be implemented as a system, a method, an integrated circuit, a computer program, a computer-readable recording medium such as a compact disc-read only memory (CD-ROM), or as any combination of systems, methods, integrated circuits, computer programs, and recording media.

An information processing device or the like according to an aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating an overview of an information processing device according to an embodiment.

FIG. 2 is a block diagram illustrating a functional configuration of an integrated monitor according to the embodiment.

FIG. 3 is a diagram illustrating an example of total monitoring information according to the embodiment.

FIG. 4 is a block diagram illustrating a functional configuration of a root monitor according to the embodiment.

FIG. 5 is a block diagram illustrating a functional configuration of an individual monitor according to the embodiment.

FIG. 6 is a diagram for describing an operation of the information processing device according to the embodiment.

FIG. 7 is a flowchart illustrating a flow of an operation of the root monitor according to the embodiment.

FIG. 8 is a flowchart illustrating a flow of an operation of each of a plurality of individual monitors according to the embodiment.

### DESCRIPTION OF EMBODIMENTS

### Underlying Knowledge Forming Basis of the Present Disclosure

The present inventors have found the following regarding the technique described in the Background section above.

With the foregoing conventional information processing device, when the monitor is compromised, the integrity of the monitoring log is not ensured.

To address this, the present inventors have devised the following information processing device and the like.

An information processing device according to a first aspect of the present disclosure is an information processing device including: a plurality of anomaly detectors each of which detects an anomaly in the information processing device; a plurality of first monitors each of which monitors an associated one of the plurality of anomaly detectors; a second monitor that monitors each of the plurality of first monitors; and a third monitor that monitors the second monitor, the third monitor being implemented in an execution environment that is more secure than an execution environment in which each of the plurality of anomaly detectors, the plurality of first monitors, and the second monitor is implemented, wherein when the second monitor is compromised, the third monitor changes a monitoring target thereof from the second monitor to any of the plurality of first monitors based on monitoring information that indicates information about the plurality of first monitors, and when the second monitor is compromised, each of the plurality of first monitors adds, to a monitoring target thereof, another first monitor than the first monitor based on the monitoring information.

According to the present aspect, when the second monitor is compromised, the third monitor changes the monitoring target thereof from the second monitor to any of the plurality of first monitors based on the monitoring information. Furthermore, when the second monitor is compromised, each of the plurality of first monitors adds, to the monitoring target thereof, another first monitor than the first monitor based on the monitoring information. Therefore, when the second monitor is compromised, a chain of monitoring can be maintained in which the third monitor monitors any of the plurality of first monitors, and each of the plurality of first monitors monitors another first monitor than the first monitor. As a result, even when the second monitor is compromised, the integrity of the monitoring log output from each of the plurality of first monitors can be ensured. In addition, the third monitor is implemented in an execution environment that is more secure than the execution environment in which each of the plurality of anomaly detectors, the plurality of first monitors, and the second monitor is implemented. The number of the monitoring targets of the third monitor is constantly one before and after the third monitor changes the monitoring target from the second monitor to any of the plurality of first monitors. Therefore, even when the processing resource of the third monitor is relatively small, the processing load of the third monitor can be reduced, and the processing resource of the third monitor can be prevented from being insufficient.

In addition, with the information processing device according to a second aspect of the present disclosure, in the first aspect, the monitoring information may be information that indicates an association between each of the plurality of first monitors and a priority, when the second monitor is compromised, the third monitor may change the monitoring target thereof from the second monitor to a first monitor having a highest priority among the plurality of first monitors based on the monitoring information, and when the second monitor is compromised, each of at least one of the plurality of first monitors may add, to the monitoring target thereof, a first monitor having a one-rank lower priority than the first monitor based on the monitoring information.

According to the present aspect, when the second monitor is compromised, the chain of monitoring by the plurality of first monitors and the third monitor can be effectively maintained.

In addition, with the information processing device according to a third aspect of the present disclosure, in the second aspect, when the second monitor is compromised, the third monitor may determine, based on the monitoring information, whether or not the first monitor having the highest priority is compromised, and (i) when the first monitor having the highest priority is not compromised, the third monitor may change the monitoring target thereof from the second monitor to the first monitor having the highest priority, and (ii) when the first monitor having the highest priority is compromised, the third monitor may change, based on the monitoring information, the monitoring target thereof from the second monitor to the first monitor having a second highest priority among the plurality of first monitors.

According to the present aspect, even when the second monitor is compromised, and the first monitor with the highest priority is compromised, the chain of monitoring can be effectively maintained since the third monitor changes the monitoring target from the second monitor to the first monitor with the second highest priority among the plurality of first monitors.

In addition, with the information processing device according to a fourth aspect of the present disclosure, in the second aspect or the third aspect, when the second monitor is compromised, each of at least one of the plurality of first monitors may determine, based on the monitoring information, whether or not a first monitor having a one-rank lower priority than the first monitor is compromised, and (i) when the first monitor having a one-rank lower priority than the first monitor is not compromised, the first monitor may add, to the monitoring target thereof, the first monitor having a one-rank lower priority than the first monitor, and (ii) when the first monitor having a one-rank lower priority than the first monitor is compromised, the first monitor may add, to the monitoring target thereof, a first monitor having a two-rank lower priority than the first monitor based on the monitoring information.

According to the present aspect, even when the second monitor is compromised, and the first monitor with a one-rank lower priority than the first monitor is compromised, the chain of monitoring can be effectively maintained since the first monitor adds, to the monitoring target, the first monitor with a two-rank lower priority than the first monitor.

In addition, with the information processing device according to a fifth aspect of the present disclosure, in any one of the second to fourth aspects, when the second monitor is compromised, a first monitor having a lowest priority among the plurality of first monitors may add, to a monitoring target thereof, the first monitor having the highest priority among the plurality of first monitors based on the monitoring information.

According to the present aspect, when the second monitor is compromised, the chain of monitoring by the plurality of first monitors and the third monitor can be effectively maintained.

A method for controlling an information processing device according to a sixth aspect of the present disclosure is a method for controlling an information processing device that includes: a plurality of anomaly detectors each of which detects an anomaly in the information processing device; a plurality of first monitors each of which monitors an associated one of the plurality of anomaly detectors; a second monitor that monitors each of the plurality of first monitors; and a third monitor that monitors the second monitor, the third monitor being implemented in an execution environment that is more secure than an execution environment in which each of the plurality of anomaly detectors, the plurality of first monitors, and the second monitor is implemented, the method including: when the second monitor is compromised, changing, by the third monitor, a monitoring target thereof from the second monitor to any of the plurality of first monitors based on monitoring information that indicates information about the plurality of first monitors; and when the second monitor is compromised, adding, by each of the plurality of first monitors, to a monitoring target thereof, another first monitor than the first monitor based on the monitoring information.

According to the present aspect, as mentioned above, even when the second monitor is compromised, the integrity of the monitoring log output from each of the plurality of first monitors can be ensured. In addition, the processing resource of the third monitor can be prevented from being insufficient.

Note that these general or specific aspects may be implemented as a system, a method, an integrated circuit, a computer program, a computer-readable recording medium such as a CD-ROM, or as any combination of systems, methods, integrated circuits, computer programs, or recording media.

In the following, an embodiment will be specifically described with reference to the drawings.

Note that the following embodiment illustrates a general or specific example. The numerical values, shapes, materials, constituent elements, the arrangement and connection of the constituent elements, steps, the processing order of the steps etc. illustrated in the following embodiment are mere examples, and are not intended to limit the present disclosure. Among the constituent elements in the following embodiment, those not recited in any of the independent claims representing the most generic concepts will be described as optional constituent elements.

### Embodiment

### 1. Overview of Information Processing Device

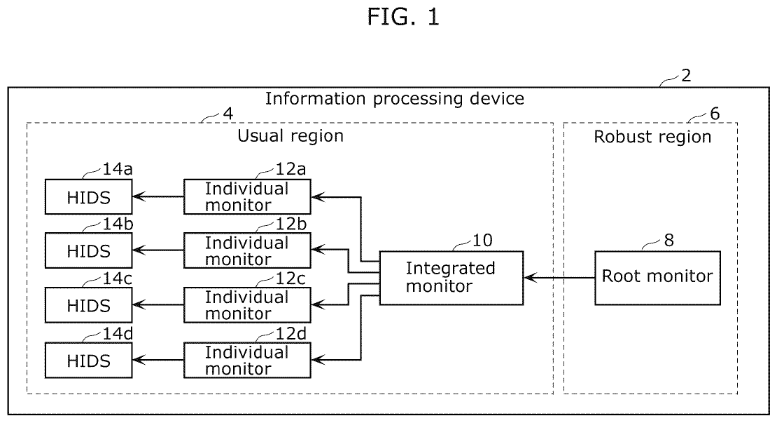

First, an overview of information processing device 2 according to an embodiment will be described with reference to FIG. 1. FIG. 1 is a diagram illustrating an overview of information processing device 2 according to the embodiment.

Information processing device 2 is applied as an electronic control unit (ECU) mounted on a vehicle, such as an automobile, for example. After activation of various computer programs (hereinafter simply referred to as program) in information processing device 2, information processing device 2 performs constant integrity (RI) verification, i.e., repeatedly performs integrity verification for the various programs.

Note that in this specification, “integrity” means that the program in information processing device 2 has not been subjected to unauthorized tampering or the like. Furthermore, “compromised” means a state of the program in information processing device 2 that has been subjected to unauthorized tampering or the like and has an integrity anomaly.

As illustrated in FIG. 1, information processing device 2 has a structure virtually separated into usual region 4 and robust region 6. Usual region 4 is an execution environment for executing an insecure operating system and an insecure application. Robust region 6 is an execution environment for executing a secure operating system and a secure application, and is isolated from usual region 4. That is, robust region 6 is a more secure execution environment than usual region 4. For example, robust region 6 is implemented (for example, subjected to obfuscation or hardening) so as to be more difficult to be analyzed than usual region 4, and access from usual region 4 to robust region 6 is restricted by a function of a processor or the like forming information processing device 2.

Note that, although not illustrated, usual region 4 has a user space and a kernel space. The user space is a memory region used by an application. The kernel space is a memory region used by a kernel.

Furthermore, root monitor 8 (an example of a third monitor), integrated monitor 10 (an example of a second monitor), a plurality of individual monitors 12a, 12b, 12c, and 12d (an example of a plurality of first monitors), and a plurality of host-based intrusion detection systems (HIDS) 14a, 14b, 14c, and 14d (an example of a plurality of anomaly detectors). In information processing device 2, root monitor 8 is used as a root of trust to perform constant integrity verification for various programs, i.e., repeatedly perform integrity verification for various programs. Note that in FIG. 1, the root of the arrow indicates a monitoring entity, and the tip of the arrow indicates a monitoring target (a monitored entity).

Note that root monitor 8, integrated monitor 10, the plurality of individual monitors 12a, 12b, 12c, and 12d (12a to 12d), and the plurality of HIDS 14a, 14b, 14c, and 14d (14a to 14d) are each implemented by a program executer, such as a central processing unit (CPU) or a processor, reading and executing a program recorded in a memory.

Root monitor 8 is implemented in robust region 6 and monitors integrated monitor 10. Specifically, after activation of integrated monitor 10, root monitor 8 performs constant integrity verification for integrated monitor 10 by repeatedly performing integrity verification for integrated monitor 10. When it is verified that integrated monitor 10 is compromised (that is, integrated monitor 10 has an integrity anomaly), root monitor 8 outputs a monitoring log that indicates the verification result.

Integrated monitor 10 is implemented in the kernel space of usual region 4 and monitors each of the plurality of individual monitors 12a to 12d. Specifically, after activation of the plurality of individual monitors 12a to 12d, integrated monitor 10 performs constant integrity verification for each of the plurality of individual monitors 12a to 12d by repeatedly performing integrity verification for each of the plurality of individual monitors 12a to 12d. When it is verified that at least one of the plurality of individual monitors 12a to 12d is compromised, integrated monitor 10 outputs a monitoring log that indicates the verification result. Note that integrated monitor 10 is disposed in a different memory space in the user space (or the kernel space) of usual region 4 than a plurality of memory spaces in which the plurality of individual monitors 12a to 12d are disposed, each individual monitor being disposed in an associated one of the memory spaces.

The plurality of individual monitors 12a to 12d are implemented in the user space (or the kernel space) of usual region 4 and monitor the plurality of HIDS 14a to 14d. Specifically, after activation of the plurality of HIDS 14a to 14d, the plurality of individual monitors 12a to 12d perform constant integrity verification for the plurality of HIDS 14a to 14d by repeatedly performing integrity verification for the plurality of HIDS 14a to 14d. When it is verified that at least one of the plurality of HIDS 14a to 14d is compromised, an associated one of the plurality of individual monitors 12a to 12d outputs a monitoring log that indicates the verification result.

Note that the plurality of individual monitors 12a to 12d are disposed in a plurality of different memory spaces in the user space (or the kernel space) of usual region 4. Therefore, even if any of the plurality of individual monitors 12a to 12d is compromised, control of the other individual monitors can be prevented from being affected by the compromised individual monitor.

Each of the plurality of HIDS 14a to 14d is implemented in the user space (or the kernel space) of usual region 4 and detects an anomaly (a false behavior of a program, for example) in information processing device 2. When detecting an anomaly in information processing device 2, each of the plurality of HIDS 14a to 14d outputs a monitoring log that indicates the detection result.

### 2. Functional Configuration of Integrated Monitor

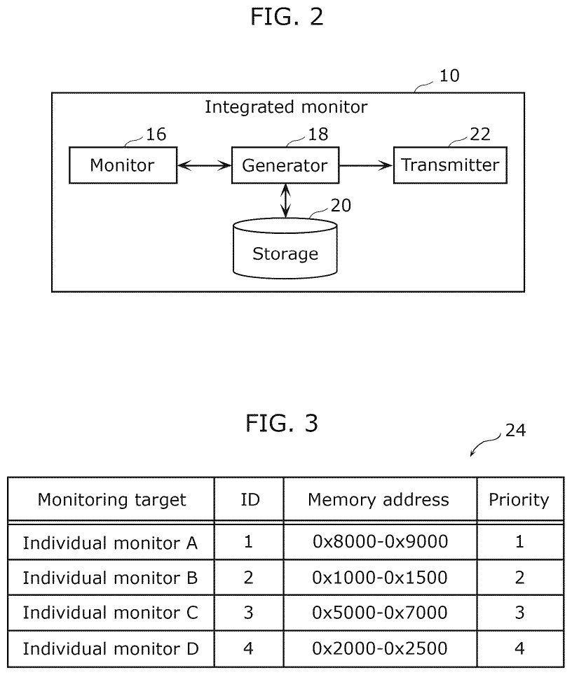

Next, with reference to FIG. 2, a functional configuration of integrated monitor 10 according to the embodiment will be described. FIG. 2 is a block diagram illustrating a functional configuration of integrated monitor 10 according to the embodiment. FIG. 3 is a diagram illustrating an example of total monitoring information 24 according to the embodiment.

As illustrated in FIG. 2, integrated monitor 10 includes monitor 16, generator 18, storage 20, and transmitter 22 as functional components.

Monitor 16 performs constant integrity verification for each of the plurality of individual monitors 12a to 12d by repeatedly performing integrity verification for each of the plurality of individual monitors 12a to 12d after activation of the plurality of individual monitors 12a to 12d. When it is verified that at least one of the plurality of individual monitors 12a to 12d is compromised, monitor 16 outputs a monitoring log that indicates the verification result. Note that monitor 16 may output a monitoring log that indicates the verification result when it is verified that at least one of the plurality of individual monitors 12a to 12d has no integrity anomaly.

Generator 18 generates total monitoring information 24 (an example of monitoring information) that indicates information about the plurality of individual monitors 12a to 12d that are monitoring target of monitor 16 by gathering information about the plurality of individual monitors 12a to 12d. Total monitoring information 24 is a data table, such as one illustrated in FIG. 3, and is information that indicates an association between each of the plurality of individual monitors 12a to 12d and the priority.

As illustrated in FIG. 3, in total monitoring information 24, a monitoring target, an ID (Identification), a memory address, and a priority are associated with each other. Here, the priority is indicated by four numerical values “1” to “4”, for example. In the present embodiment, the higher the numerical value of the priority, the higher the priority is. The priority “1” to “4” is assigned to the plurality of individual monitors 12a to 12d in advance. Specifically, among the plurality of individual monitors 12a to 12d, individual monitors 12d is assigned the highest priority, individual monitor 12c is assigned the second highest priority, individual monitors 12b is assigned the third highest priority, and individual monitor 12a is assigned the lowest priority. For example, higher priorities are assigned to individual monitors disposed in the kernel space, and lower priorities are assigned to individual monitors that use open source software (OSS), which has a general vulnerability.

Note that in total monitoring information 24 illustrated in FIG. 3, “individual monitor A”, “individual monitor B”, “individual monitor C”, and “individual monitor D” mean the plurality of individual monitors 12a, 12b, 12c, and 12d, respectively.

In the example illustrated in FIG. 3, in the first row of total monitoring information 24, a) monitoring target “individual monitor A” (individual monitor 12a), b) ID “1” for identifying individual monitor A, c) memory address “0x8000-0x9000” assigned to individual monitor A, and d) priority “1” assigned to individual monitor A are associated and stored.

Furthermore, in the second row of total monitoring information 24, a) monitoring target “individual monitor B” (individual monitor 12b), b) ID “2” for identifying individual monitor B, c) memory address “0x1000-0x1500” assigned to individual monitor B, and d) priority “2” assigned to individual monitor B are associated and stored.

Furthermore, in the third row of total monitoring information 24, a) monitoring target “individual monitor C” (individual monitor 12c), b) ID “3” for identifying individual monitor C, c) memory address “0x5000-0x7000” assigned to individual monitor C, and d) priority “3” assigned to individual monitor C are associated and stored.

Furthermore, in the fourth row of total monitoring information 24, a) monitoring target “individual monitor D” (individual monitor 12d), b) ID “4” for identifying individual monitor D, c) memory address “0x2000-0x2500” assigned to individual monitor D, and d) priority “4” assigned to individual monitor D are associated and stored.

Referring back to FIG. 2, storage 20 is a memory that stores total monitoring information 24 generated by generator 18.

Transmitter 22 transmits total monitoring information 24 generated by generator 18 to root monitor 8 and each of the plurality of individual monitors 12a to 12d.

### 3. Functional Configuration of Root Monitor

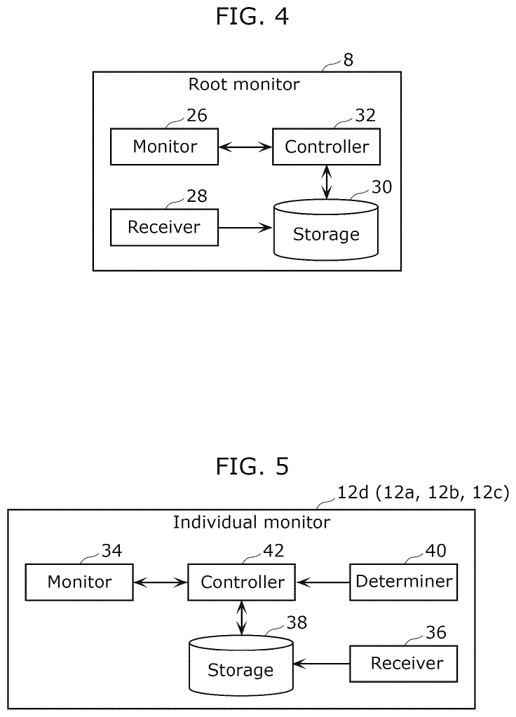

Next, with reference to FIG. 4, a functional configuration of root monitor 8 according to the embodiment will be described. FIG. 4 is a block diagram illustrating a functional configuration of root monitor 8 according to the embodiment.

As illustrated in FIG. 4, root monitor 8 includes monitor 26, receiver 28, storage 30, and controller 32 as functional components.

Monitor 26 performs constant integrity verification for integrated monitor 10 by repeatedly performing integrity verification for integrated monitor 10 after activation of integrated monitor 10. When it is verified that integrated monitor 10 is compromised, monitor 26 outputs a monitoring log that indicates the verification result. Note that monitor 26 may output a monitoring log that indicates the verification result when it is verified that integrated monitor 10 has no integrity anomaly.

Receiver 28 receives total monitoring information 24 from integrated monitor 10 and stores received total monitoring information 24 in storage 30.

Storage 30 is a memory that stores total monitoring information 24 received by receiver 28.

Based on the monitoring log from monitor 26, controller 32 determines whether or not integrated monitor 10 is compromised. When it is determined that integrated monitor 10 is compromised, based on total monitoring information 24 stored in storage 30, controller 32 changes the monitoring target of monitor 26 from integrated monitor 10 to any of the plurality of individual monitors 12a to 12d. More specifically, when it is determined that integrated monitor 10 is compromised, based on total monitoring information 24, controller 32 changes the monitoring target of monitor 26 from integrated monitor 10 to individual monitor 12d, which has the highest priority (specifically, priority “4”) among the plurality of individual monitors 12a to 12d.

### 4. Functional Configuration of Individual Monitor

Next, with reference to FIG. 5, a functional configuration of individual monitor 12d according to the embodiment will be described. FIG. 5 is a block diagram illustrating a functional configuration of individual monitor 12d according to the embodiment. Note that the plurality of individual monitors 12a to 12d have the same configuration, and therefore, only the configuration of individual monitor 12d will be described below.

As illustrated in FIG. 5, individual monitor 12d includes monitor 34, receiver 36, storage 38, determiner 40, and controller 42 as functional components.

Monitor 34 performs constant integrity verification for HIDS 14d by repeatedly performing integrity verification for HIDS 14d after activation of HIDS 14d. When it is verified that HIDS 14d is compromised, monitor 34 outputs a monitoring log that indicates the verification result. Note that monitor 34 may output a monitoring log that indicates the verification result when it is verified that HIDS 14d has no integrity anomaly.

Receiver 36 receives total monitoring information 24 from integrated monitor 10 and stores received total monitoring information 24 in storage 38.

Storage 38 is a memory that stores total monitoring information 24 received by receiver 36.

Determiner 40 determines whether or not the monitoring entity for individual monitor 12d has been changed.

When determiner 40 determines that the monitoring entity for individual monitor 12d has been changed, based on the determination result from determiner 40, controller 42 determines that integrated monitor 10 is compromised. When it is determined that integrated monitor 10 is compromised, based on total monitoring information 24 stored in storage 38, controller 42 adds, to the monitoring target, any of other individual monitors 12a to 12c than individual monitor 12d. More specifically, when integrated monitor 10 is compromised, based on total monitoring information 24, controller 42 adds, to the monitoring target of monitor 34, individual monitor 12c having a one-rank lower priority than individual monitor 12d (specifically, priority “3”).

### 5. Operation of Information Processing Device

### [5-1. Operation of Root Monitor]

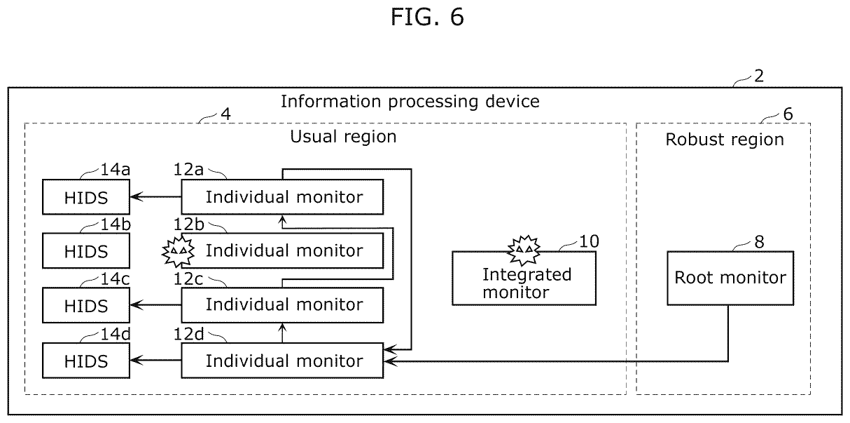

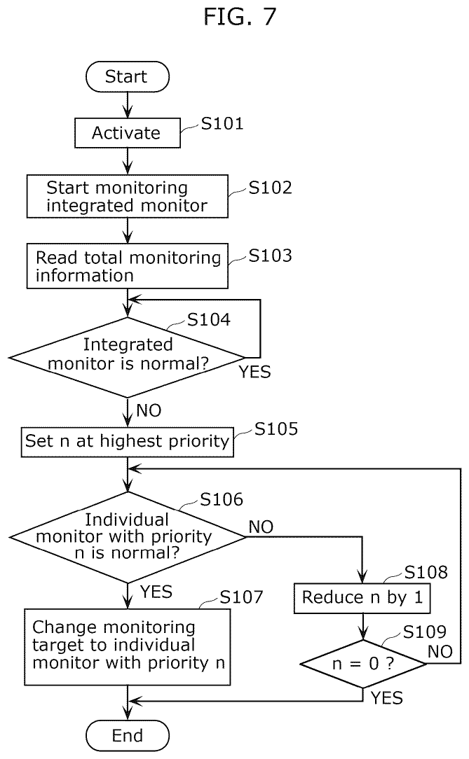

Next, with reference to FIGS. 6 and 7, an operation of root monitor 8 according to the embodiment will be described. FIG. 6 is a diagram for describing an operation of information processing device 2 according to the embodiment. FIG. 7 is a flowchart illustrating a flow of an operation of root monitor 8 according to the embodiment.

First, an operation of root monitor 8 in a case where integrated monitor 10 and individual monitor 12b are compromised as illustrated in FIG. 6 will be described. Note that in FIG. 6, the root of the arrow indicates a monitoring entity, and the tip of the arrow indicates a monitoring target (a monitored entity).

As illustrated in FIG. 7, when information processing device 2 is activated (S101), monitor 26 starts monitoring of integrated monitor 10 (S102). Controller 32 then reads total monitoring information 24 from storage 30 (S103). Note that although step S103 is performed after step S102 in the present embodiment, step S102 may be performed after step S103.

After step S103, based on the monitoring log from monitor 26, controller 32 determines whether or not integrated monitor 10 is compromised (in other words, whether or not integrated monitor 10 is normal) (S104). When integrated monitor 10 is compromised (NO in S104), based on total monitoring information 24, controller 32 sets variable n at “4”, which means the highest priority (variable n=4) (S105).

Based on total monitoring information 24, controller 32 then determines whether or not individual monitor 12d with priority “4” corresponding to variable n (=4) (in other words, with the highest priority) is compromised (in other words, whether or not individual monitor 12d is normal) (S106). When individual monitor 12d is not compromised (YES in S106), controller 32 changes the monitoring target of monitor 26 from integrated monitor 10 to individual monitor 12d with the highest priority “4” (S107). Then, the processing of the flowchart of FIG. 7 ends.

Next, an operation of root monitor 8 in a case where integrated monitor 10 and individual monitor 12d are compromised will be described.

As illustrated in FIG. 7, steps S101 to S105 are performed as in the case described above. After step S105, when individual monitor 12d is compromised (NO in S106), controller 32 reduces variable n from “4” to “3” by 1 (i.e., sets variable n=3) (S108). In this case, since variable n>0 (NO in S109), the process returns to step S106. Based on total monitoring information 24, controller 32 then determines whether or not individual monitor 12c with priority “3” corresponding to variable n (=3) (in other words, with the second highest priority) is compromised (S106).

When individual monitor 12c is not compromised (YES in S106), controller 32 changes the monitoring target of monitor 26 from integrated monitor 10 to individual monitor 12c with the second highest priority (S107). Then, the processing of the flowchart of FIG. 7 ends.

Next, an operation of root monitor 8 in a case where integrated monitor 10 and the plurality of individual monitors 12a to 12d are compromised will be described.

As illustrated in FIG. 7, steps S101 to S105 are performed as in the case described above. After step S105, when individual monitor 12d is compromised (NO in S106), controller 32 reduces variable n from “4” to “3” by 1 (i.e., sets variable n=3) (S108). In this case, since variable n>0 (NO in S109), the process returns to step S106.

Based on total monitoring information 24, controller 32 then determines whether or not individual monitor 12c with priority “3” corresponding to variable n (=3) (in other words, with the second highest priority) is compromised (S106). When individual monitor 12c is compromised (NO in S106), controller 32 reduces variable n from “3” to “2” by 1 (i.e., sets variable n=2) (S108). In this case, since variable n>0 (NO in S109), the process returns to step S106.

Based on total monitoring information 24, controller 32 then determines whether or not individual monitor 12b with priority “2” corresponding to variable n (=2) (in other words, with the third highest priority) is compromised (S106). When individual monitor 12b is compromised (NO in S106), controller 32 reduces variable n from “2” to “1” by 1 (i.e., sets variable n=1) (S108). In this case, since variable n>0 (NO in S109), the process returns to step S106.

Based on total monitoring information 24, controller 32 then determines whether or not individual monitor 12a with priority “1” corresponding to variable n (=1) (in other words, with the lowest priority) is compromised (S106). When individual monitor 12a is compromised (NO in S106), controller 32 reduces variable n from “1” to “0” by 1 (i.e., sets variable n=0) (S108). In this case, since variable n=0 (YES in S109), controller 32 ends the process, and the processing of the flowchart of FIG. 7 ends.

Finally, an operation of root monitor 8 in a case where integrated monitor 10 is not compromised will be described.

After steps S101 to S103 are performed as in the cases described above, when integrated monitor 10 is not compromised (YES in S104), step S104 is repeatedly performed until integrated monitor 10 is compromised.

### [5-2. Operation of Individual Monitor]

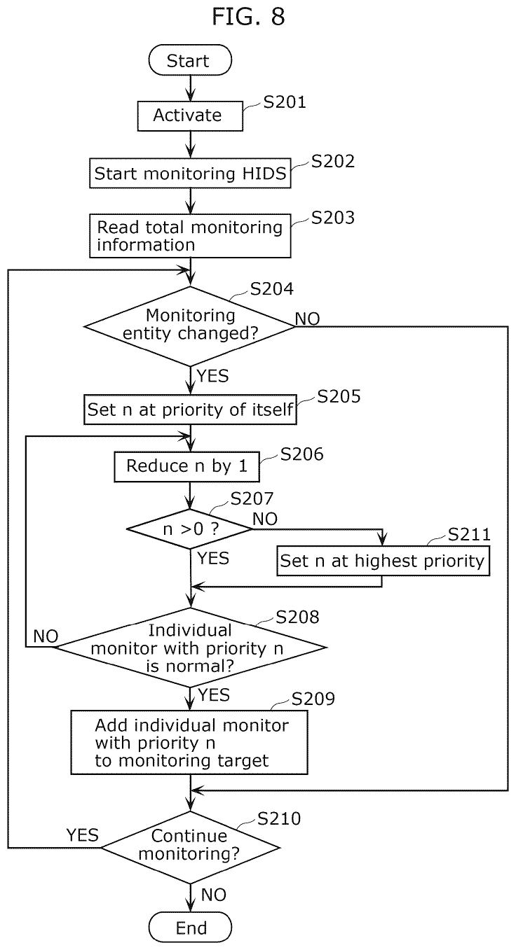

Next, with reference to FIGS. 6 and 8, an operation of each of the plurality of individual monitors 12a to 12d according to the embodiment will be described. FIG. 8 is a flowchart illustrating a flow of an operation of each of the plurality of individual monitors 12a to 12d according to the embodiment.

First, an operation of individual monitor 12d in a case where integrated monitor 10 and individual monitor 12b are compromised as illustrated in FIG. 6 will be described.

As illustrated in FIG. 8, when information processing device 2 is activated (S201), monitor 34 of individual monitor 12d starts monitoring of HIDS 14d (S202). Controller 42 of individual monitor 12d then reads total monitoring information 24 from storage 38 of individual monitor 12d (S203). Note that although step S203 is performed after step S202 in the present embodiment, step S202 may be performed after step S203.

After step S203, determiner 40 of individual monitor 12d determines whether or not the monitoring entity (integrated monitor 10) for individual monitor 12d is changed (S204). As described above, when integrated monitor 10 is compromised and thus the monitoring entity for individual monitor 12d is changed from integrated monitor 10 to root monitor 8 (YES in S204), controller 42 of individual monitor 12d determines that integrated monitor 10 is compromised, based on the determination result from determiner 40 of individual monitor 12d. Then, based on total monitoring information 24, controller 42 of individual monitor 12d sets variable n at “4”, which is the priority of itself (individual monitor 12d) (variable n=4) (S205).

Controller 42 of individual monitor 12d then reduces variable n from “4” to “3” by 1 (i.e., sets variable n=3) (S206). In this case, since variable n>0 (YES in S207), based on total monitoring information 24, controller 42 of individual monitor 12d determines whether or not individual monitor 12c with priority “3” corresponding to variable n (=3) (in other words, with a one-rank lower priority than individual monitor 12d) is compromised (that is, whether or not individual monitor 12c is normal) (S208).

When individual monitor 12c is not compromised (YES in S208), controller 42 of individual monitor 12d adds individual monitor 12c with priority “3” to the monitoring target of monitor 34 (S209). Then, monitor 34 of individual monitor 12d performs not only constant integrity verification for HIDS 14d but also constant integrity verification for individual monitor 12c.

After step S209, when to continue monitoring (YES in S210), the process returns to step S204. In this case, since the monitoring entity (root monitor 8) for individual monitor 12d is not changed (NO in S204), the process proceeds to step S210. On the other hand, after step S209, when to end monitoring (NO in S210), the processing of the flowchart of FIG. 8 ends.

Next, an operation of individual monitor 12c in a case where integrated monitor 10 and individual monitor 12b as illustrated in FIG. 6 are compromised will be described.

As illustrated in FIG. 8, steps S201 to S204 are performed as in the case described above. In step S205, based on total monitoring information 24, controller 42 of individual monitor 12c sets variable n at “3”, which is the priority of itself (individual monitor 12c) (variable n=3). Controller 42 of individual monitor 12c then reduces variable n from “3” to “2” by 1 (i.e., sets variable n=2) (S206). In this case, since variable n>0 (YES in S207), based on total monitoring information 24, controller 42 of individual monitor 12c determines whether or not individual monitor 12b with priority “2” corresponding to variable n (=2) (in other words, with a one-rank lower priority than individual monitor 12c) is compromised (S208).

When individual monitor 12b is compromised (NO in S208), the process returns to step S206, and controller 42 of individual monitor 12c reduces variable n from “2” to “1” by 1 (i.e., sets variable n=1) (S206). In this case, since variable n>0 (YES in S207), based on total monitoring information 24, controller 42 of individual monitor 12c determines whether or not individual monitor 12a with priority “1” corresponding to variable n (=1) (in other words, with a two-rank lower priority than individual monitor 12c) is compromised (S208).

When individual monitor 12a is not compromised (YES in S208), controller 42 of individual monitor 12c adds individual monitor 12a with priority “1” to the monitoring target of monitor 34 (S209). Then, monitor 34 of individual monitor 12c performs not only constant integrity verification for HIDS 14c but also constant integrity verification for individual monitor 12a. The process then proceeds to step S210.

Next, an operation of individual monitor 12a in a case where integrated monitor 10 and individual monitor 12b are compromised as illustrated in FIG. 6 will be described.

As illustrated in FIG. 8, steps S201 to S204 are performed as in the case described above. In step S205, based on total monitoring information 24, controller 42 of individual monitor 12a sets variable n at “1”, which is the priority of itself (individual monitor 12a) (variable n=1). Controller 42 of individual monitor 12a then reduces variable n from “1” to “0” by 1 (i.e., sets variable n=0) (S206). In this case, since variable n=0 (NO in S207), based on total monitoring information 24, controller 42 of individual monitor 12a sets variable n at “4”, which means the highest priority (variable n=4) (S211). Based on total monitoring information 24, controller 42 of individual monitor 12a then determines whether or not individual monitor 12d with priority “4” corresponding to variable n (=4) (in other words, with the highest priority) is compromised (S208).

When individual monitor 12d is not compromised (YES in S208), controller 42 of individual monitor 12a adds individual monitor 12d with priority “4” to the monitoring target of monitor 34 (S209). Then, monitor 34 of individual monitor 12a performs not only constant integrity verification for HIDS 14a but also constant integrity verification for individual monitor 12d. The process then proceeds to step S210.

### 6. Advantageous Effects

According to the present embodiment, when integrated monitor 10 is compromised, based on total monitoring information 24, root monitor 8 changes the monitoring target from integrated monitor 10 to any of the plurality of individual monitors 12a to 12d. Furthermore, when integrated monitor 10 is compromised, based on total monitoring information 24, each of the plurality of individual monitor 12a to 12d adds another individual monitor than the individual monitor to the monitoring target.

Thus, when integrated monitor 10 and individual monitor 12b are compromised as illustrated in FIG. 6, for example, a chain of monitoring can be maintained in which a) root monitor 8 monitors individual monitor 12d, b) individual monitor 12d monitors individual monitor 12c, c) individual monitor 12c monitors individual monitor 12a, and d) individual monitor 12a monitors individual monitor 12d. As a result, even if integrated monitor 10 and individual monitor 12b are compromised, for example, the integrity of the monitoring log output from each of the plurality of individual monitors 12a, 12c, and 12d can be ensured.

In addition, the processing resource allocated to robust region 6 is less than the processing resource allocated to usual region 4. In the present embodiment, the number of the monitoring targets of root monitor 8 is constantly one before and after root monitor 8 changes the monitoring target from integrated monitor 10 to any of the plurality of individual monitors 12a to 12d. Therefore, the processing load (the processing time, the memory capacity, and the access overhead from robust region 6 to usual region 4, for example) required for root monitor 8 to perform constant integrity verification in robust region 6 can be reduced, and the processing resource of robust region 6 can be prevented from being insufficient.

### Other Variations Etc

An information processing device and a method for controlling an information processing device according to one or more aspects have been described above based on the above embodiment, but the present disclosure is not limited to the above embodiment. The one or more aspects may include forms achieved by making various modifications to the above embodiment that can be conceived by those skilled in the art, as well as forms achieved by combining constituent elements in different embodiments, without materially departing from the spirit of the present disclosure.

In the embodiment described above, the host-based Ids (HIDS) is used as an anomaly detector. However, this is not intended to be limiting. For example, a network-based intrusion detection system (NIDS) or the like may be used.

Note that, in the above embodiment, the constituent elements may be configured in the form of dedicated hardware or may be implemented by executing a computer program suited to the constituent elements. The constituent elements may be implemented by a program executor such as a CPU or a processor reading out and executing the computer program recorded on a recording medium such as a hard disk or semiconductor memory.

Some or all of the functions of information processing device 2 according to the above embodiment may be achieved by a processor such as a CPU executing a computer program.

Some or all of the constituent elements included in each device described above may be configured as an IC card that is detachably attached to each device, or as a stand-alone module. The IC card and the module are computer systems each including a microprocessor, ROM, and RAM, for example. The IC card and the module may include the super-multifunction LSI circuit described above. The IC card and the module achieve their function as a result of the microprocessor operating according to a computer program. The IC card and the module may be tamperproof.

The present disclosure may be the methods described above. In addition, the present disclosure may be a computer program that implements these methods with a computer, or a digital signal that includes the computer program. The present disclosure may also be implemented as a non-transitory computer-readable recording medium, such as a flexible disk, a hard disk, a CD-ROM, an MO, a DVD, a DVD-ROM, DVD-RAM, a Blu-ray Disc (BD; registered trademark), semiconductor memory, etc., having recording thereon the computer program or the digital signal. Moreover, the present disclosure may also be implemented as the digital signal recorded on these recording media. In addition, the present disclosure may transmit the computer program or the digital signal via, for example, a telecommunication line, a wireless or wired communication line, a network such as the Internet, or data broadcasting. The present disclosure may also be implemented as a computer system including (i) memory having the computer program stored therein and (ii) a microprocessor that operates according to the computer program. In addition, the computer program or the digital signal may be implemented by another independent computer system by recording the computer program or the digital signal on the recording medium and transporting it, or by transporting the computer program or the digital signal via the network, etc.

While various embodiments have been described herein above, it is to be appreciated that various changes in form and detail may be made without departing from the spirit and scope of the present disclosure as presently or hereafter claimed.

### Further Information about Technical Background to this Application

The disclosures of the following patent applications including specification, drawings, and claims are incorporated herein by reference in their entirety: Japanese Patent Application No. 2022-153318 filed on Sep. 27, 2022 and PCT International Application No. PCT/JP2023/026176 filed on Jul. 18, 2023.

### INDUSTRIAL APPLICABILITY

The present disclosure is applicable to, for example, an information processing device for performing constant integrity verification for various programs in an in-vehicle network.

1. An information processing device comprising:
a plurality of anomaly detectors each of which detects an anomaly in the information processing device;
a plurality of first monitors each of which monitors an associated one of the plurality of anomaly detectors;
a second monitor that monitors each of the plurality of first monitors; and
a third monitor that monitors the second monitor, the third monitor being implemented in an execution environment that is more secure than an execution environment in which each of the plurality of anomaly detectors, the plurality of first monitors, and the second monitor is implemented, wherein
when the second monitor is compromised, the third monitor changes a monitoring target thereof from the second monitor to any of the plurality of first monitors based on monitoring information that indicates information about the plurality of first monitors, and
when the second monitor is compromised, each of the plurality of first monitors adds, to a monitoring target thereof, another first monitor than the first monitor based on the monitoring information.

2. The information processing device according to claim 1, wherein
the monitoring information is information that indicates an association between each of the plurality of first monitors and a priority,
when the second monitor is compromised, the third monitor changes the monitoring target thereof from the second monitor to a first monitor having a highest priority among the plurality of first monitors based on the monitoring information, and
when the second monitor is compromised, each of at least one of the plurality of first monitors adds, to the monitoring target thereof, a first monitor having a one-rank lower priority than the first monitor based on the monitoring information.

3. The information processing device according to claim 2, wherein
when the second monitor is compromised, the third monitor determines, based on the monitoring information, whether or not the first monitor having the highest priority is compromised, and (i) when the first monitor having the highest priority is not compromised, the third monitor changes the monitoring target thereof from the second monitor to the first monitor having the highest priority, and (ii) when the first monitor having the highest priority is compromised, the third monitor changes, based on the monitoring information, the monitoring target thereof from the second monitor to the first monitor having a second highest priority among the plurality of first monitors.

4. The information processing device according to claim 2, wherein
when the second monitor is compromised, each of at least one of the plurality of first monitors determines, based on the monitoring information, whether or not a first monitor having a one-rank lower priority than the first monitor is compromised, and (i) when the first monitor having a one-rank lower priority than the first monitor is not compromised, the first monitor adds, to the monitoring target thereof, the first monitor having a one-rank lower priority than the first monitor, and (ii) when the first monitor having a one-rank lower priority than the first monitor is compromised, the first monitor adds, to the monitoring target thereof, a first monitor having a two-rank lower priority than the first monitor based on the monitoring information.

5. The information processing device according to claim 2, wherein
when the second monitor is compromised, a first monitor having a lowest priority among the plurality of first monitors adds, to a monitoring target thereof, the first monitor having the highest priority among the plurality of first monitors based on the monitoring information.

6. A method for controlling an information processing device,
the information processing device including:
a plurality of anomaly detectors each of which detects an anomaly in the information processing device;
a plurality of first monitors each of which monitors an associated one of the plurality of anomaly detectors;
a second monitor that monitors each of the plurality of first monitors; and
a third monitor that monitors the second monitor, the third monitor being implemented in an execution environment that is more secure than an execution environment in which each of the plurality of anomaly detectors, the plurality of first monitors, and the second monitor is implemented,
the method comprising:
when the second monitor is compromised, changing, by the third monitor, a monitoring target thereof from the second monitor to any of the plurality of first monitors based on monitoring information that indicates information about the plurality of first monitors; and
when the second monitor is compromised, adding, by each of the plurality of first monitors, to a monitoring target thereof, another first monitor than the first monitor based on the monitoring information.
